(19) United States
(12) Patent Application Publication
(10) Pub. No.: US 2025/0112380 A1
(43) Pub. Date: Apr. 3, 2025

(54) WIDEBAND ANTENNA WITH MODULAR ASSEMBLY

(71) Applicant: Raytheon Company, Waltham, MA (US)

(72) Inventors: Robert S. Isom, Allen, TX (US); Randy L. Smith, Dallas, TX (US); Kelsey Joe Viani-Wittwer, Leonard, TX (US); Paul Raymond Winniford, Richardson, TX (US)

(21) Appl. No.: 18/477,594

(22) Filed: Sep. 29, 2023

(51) Int. Cl. H01Q 21/00; H01Q 5/335

(52) U.S. Cl. CPC H01Q 21/0025; H01Q 5/335

(57) ABSTRACT

A wideband antenna array includes a wide angle impedance matching (waim) board, a manifold board including multiple tower receiving features and at least one conductive tower extending outward from the manifold board and received in a corresponding tower receiving feature. Each of the at least one conductive towers including at least one metalized component. The metalized component forms a circuit connecting the manifold board to the waim board. The waim board is adhered to a first end of the at least one conductive tower opposite the manifold board.

### BACKGROUND

The present disclosure relates to wideband antenna designs, and more particularly to a modular wideband assembly design.

Wideband antennas are antennas that are configured such that they have approximately, or exactly, the same operating characteristics across a wide passband. Existing antenna arrays able to provide wideband performance have high manufacturing costs as the assembly cannot be automated, and the typical designs are not modular. The lack of modularity further causes additional coefficient of thermal expansion (CTE) related stress as the antenna array is exposed to varied temperatures over time. Similar lower cost designs (e.g. a loop radiator design) can provide some wideband coverage but are unable to be used at lower frequencies due to height requirements for lower frequencies exceeding current manufacturing capabilities and a resultant limited frequency bandwidth.

It is desirable to create a wideband antenna array that can be constructed cheaply in a modular configuration while retaining a full wideband array passband.

### SUMMARY

According to one embodiment, a wideband antenna array including a wide angle impedance matching (waim) board, a manifold board including a plurality of tower receiving features, and at least one conductive tower extending outward from the manifold board and received in a corresponding tower receiving feature, each of the at least one conductive towers including at least one metalized component, the metalized component forming a circuit connecting the manifold board to the waim board, and wherein the waim board is adhered to a first end of the at least one conductive tower, the first end being opposite the manifold board.

According to another embodiment, a method for assembling a wideband antenna array includes disposing a plurality of conductive towers in a manifold board such that a first end of each tower is received in a corresponding receiving feature of the manifold board, disposing a wide-angle impedance matching (waim) board at a second end, opposite the first end, of each tower such that at least one metalized component of each conductive tower forms a circuit connecting the manifold board to the waim board, and adhering the conductive tower to the manifold board and the waim board via one of a conductive solder and a conductive epoxy.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 schematically illustrates an isometric view of a modular wideband antenna array;

FIG. 2 schematically illustrates a partial exploded side view of the modular wideband antenna array of FIG. 1;

FIG. 3A schematically illustrates a conductive tower subassembly;

FIG. 3B schematically illustrates a zoomed in portion of the conductive tower subassembly from a different angle.

FIG. 4 schematically illustrates a manifold board subassembly; and

FIG. 5A schematically illustrates a layer of a wide-angle impedance matching board subassembly;

FIG. 5B schematically illustrates a layer of a wide-angle impedance matching board subassembly;

FIG. 5C schematically illustrates a layer of a wide-angle impedance matching board subassembly;

FIG. 5D schematically illustrates a layer of a wide-angle impedance matching board subassembly; and

FIG. 5E schematically illustrates a layer of a wide-angle impedance matching board subassembly.

### DETAILED DESCRIPTION

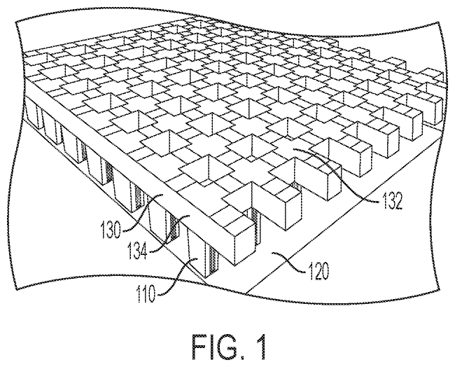

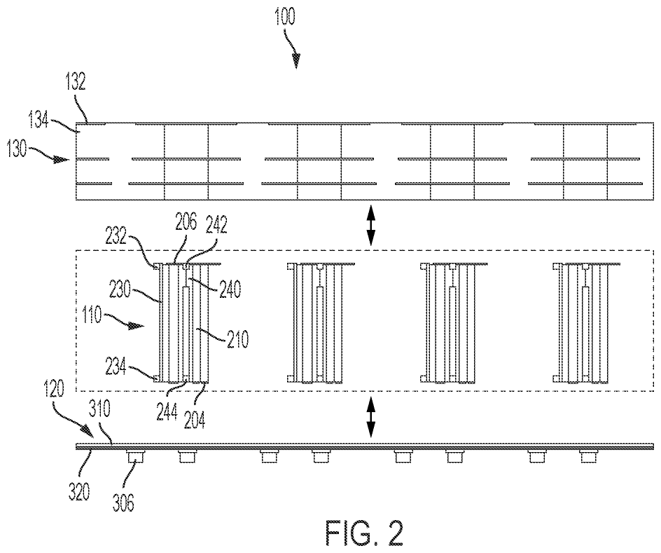

FIG. 1 illustrates an isometric view of a modular wideband antenna array 100. FIG. 2 illustrates a partial side view of the construction of FIG. 1

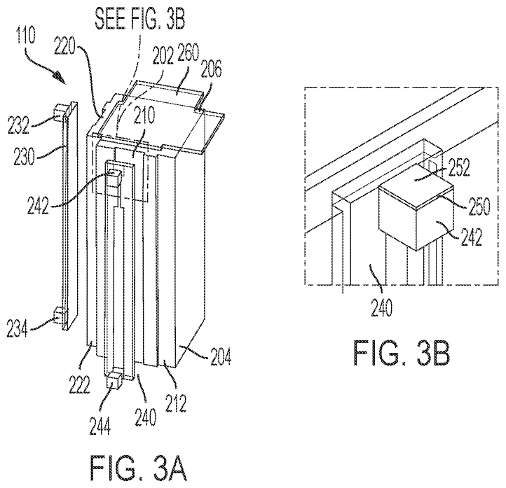

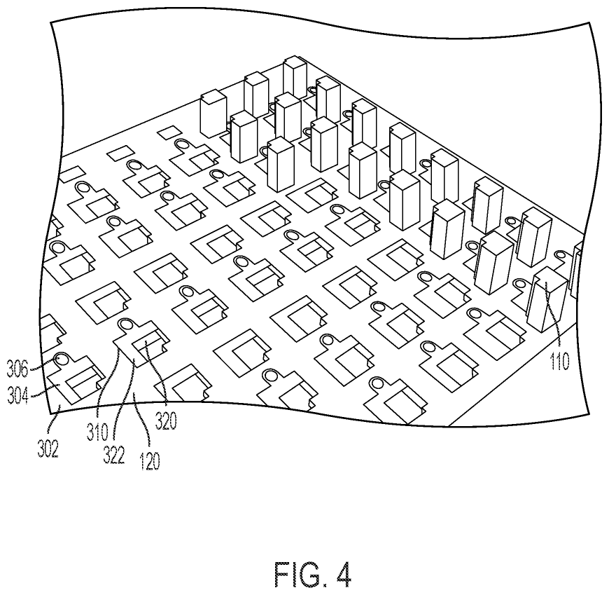

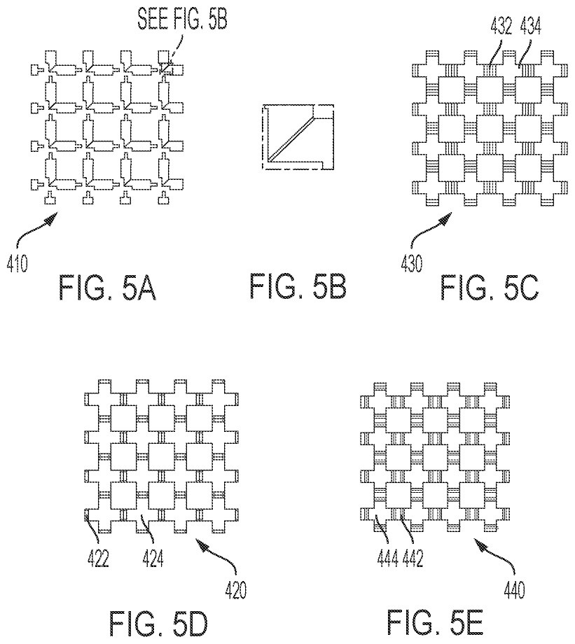

The modular wideband antenna array 100 is constructed of three subassemblies: a set of conductive towers 110 (illustrated in FIG. 3), a conductive manifold board 120 (illustrated in FIG. 4) on which the conductive metalized posts 110 are mounted in a grid pattern, and a layered wide angle impedance matching (waim) board 130 (illustrated in FIGS. 5 and 6) connected to an end of each conductive metalized post 110 opposite the conductive manifold board 120. The layered waim board 130 includes alternating conductive and conductive layers, with the conductive layers being capacitively coupled to each other.

The three subassemblies can be manufactured separately and assembled into the full assembly using an automated or semiautomated assembly process, with the footprint of the antenna being scalable from small (singular tower) to large (theoretically infinite tower) arrays. Antenna constructed using the three subassemblies disclosed herein result in a lower frequency, broader bandwidth, lighter weight and lower cost than similarly sized wideband antenna of other designs. In addition, the construction using three sub-assemblies reduces the stresses associated with thermal expansion/contraction, thereby increasing the lifecycle of the antenna and/or allowing the antenna to be utilized in less hospitable environments.

Turning initially to the conductive tower 110 sub assembly, FIG. 3 illustrates an isometric view of the conductive tower 110, and a zoomed in partial view 202 of one region of the conductive tower 110. The exemplary tower 110 includes a first end 204 and extends to a second end 206, with the ends 204, 206being approximately parallel. The conductive tower 110 includes a generally rectangular cross section. A first slot 210 is defined on a face 212 normal to the first and second ends 204, 206. Also included is a second slot 220 defined on a second face 222 normal to the first and second ends 204.

A conductive vertical circuit component (conductive component 230, 240) is received in each of the slots 210, 220 and is maintained in place using a conductive adhesive. In one example, the conductive adhesive is a silver epoxy. In alternative examples, the conductive adhesive can be a solder material. At each end of the conductive component 230, 240 is a tab 232, 234, 242, 244. Each tab 232, 234, 242, 244 is adhered to the corresponding conductive component via the conductive adhesive. The tabs 232, 234, 242, 244 also include at least one face 250 aligned with the corresponding end 204, 206 face of the conductive tower 110, and a conductive adhesive pad is disposed on the at least one face 250. In one example, the towers 110 are symmetrical such that they can be functionally installed in the antenna assembly with either end 204, 206 contacting either the manifold board 120 or the waim board 130.

With reference to FIGS. 1 and 2, as well as FIG. 3, the conductive epoxy and conductive component 240 form a vertical circuit that electrically connects a conductive layer of the waim board 130 to the manifold board 120, allowing the completed assembly 100 to operate as a wideband antenna. While the conductive tower 110 isn't directly connected to the radiator layer 260, the tower 110 is capacitively coupled to the radiator layer 260 and provides a ground path for the circuit. In one practical example, all of the towers 110 are substantially identical. In an alternative example, a portion of the towers 110 (e.g., towers 110 disposed on the outer edge of the array) may have a slightly different cross-sectional shape, while maintaining the same electrical properties. The towers 110 are constructed of any lightweight, machinable, non-conductive material and are metal- or conductive material plated on one or more surface. In one example, a suitable material that can be utilized is polyetherimide such as the branded Ultem. In one alternative, a conductive polymer could also be used in place of the non-conductive material and plating process.

With continued reference to FIGS. 1-3, FIG. 4 schematically illustrates a manifold board 120 in greater detail. The exemplary manifold board includes two layers 302, 304 of a conductive material, with the layers 302, 304 being maintained in position relative to each other via mechanical fasteners 306. Included in each of the layers 302, 304 are cutouts 310, 320, with the cutouts 310, 320 being shaped to receive an end 204, 206 face of a corresponding tower 110 and have the tabs 234, 244 of the received end 204, 206 of the tower 110 electrically contact, and connect with, the second layer 304 of the manifold board 120. The combined structures of the cutouts 310, 320 are referred to as a receiving feature.

In the illustrated example, the second layer cutout 320 provides landing portions 322 that are substantially larger than the corresponding tabs 234, 244 being received on the second layer 320. This size discrepancy accommodates large tolerance variations in both manufacturing the towers 110 and assembling the wideband antenna. This in turn further eases the ability of the wideband antenna assembly 100 to be assembled via automated systems or semi-automated systems.

In some examples, the finished assembly can include a tower 110 received in every receiving feature of the manifold board 120. In other examples, where a smaller antenna is required a standardized size manifold board 120 can be utilized, with less than all of the receiving features receiving a corresponding tower 110. Furthermore, in alternate examples, the manifold board 120 can have custom dimensions and the antenna array can be sized accordingly.

With continued reference to FIGS. 1-4, FIGS. 5A-E schematically illustrates multiple layers 410, 420, 430, 440 which are stacked to form the waim board 130 (illustrated in FIG. 2 in an assembled state) the layers 410, 420, 430, 440 can be adhered together using any foamboard adherence process. The first layer 410, is a conductive material layer which contacts the tabs 232, 242 of the towers 110 and forms distinct circuits with the conductive component of the tower 110 and the manifold board 120. The first layer 410 is disposed on a bottom side of the second layer 420. The second layer 420 is a combination of a light-weight non-conductive layer 422, with a second conductive material layer 422 disposed on an opposite end of the non-conductive layer 422 as the first conductive layer 410. Each of the third layer 430 and the second layer 440 are similarly arranged with a non-conductive layer 432, 442 contacting the previous layer 420, 430 and a conductive material layer 434, 444 positioned on the opposite side of the non-conductive layer 432, 442. The non-conductive layers 422, 432, 442 are, in one example constructed of a foam material such as an open or closed cell Ethylene-Vinyl Acetate (EVA) foam. In one example, the conductive portions are a copper material. In alternate examples, another electrically conductive material able to be formed as a thin sheet can be utilized.

With reference to all of FIGS. 1-5E, the modular low-cost tower design described herein improves the producibility of the three-assembly structure by utilizing easily machinable materials and being able to be tooled to accept radio frequency circuits, in the form of the electrically conductive components, as vertical traces along the side of each tower. The tab design allows for the towers to be simply placed within the manifold board and adhered in position, allowing for easier machine-based automated or semi-automated assembly. Further, the modular nature of the assembly allows for a tile-to-tile connection and theoretically infinite size scaling.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form detailed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the various embodiments with various modifications as are suited to the particular use contemplated.

While the preferred embodiments have been described, it will be understood that those skilled in the art, both now and in the future, may make various improvements and enhancements which fall within the scope of the claims which follow. These claims should be construed to maintain the proper protection for the disclosure as first described.

What is claimed is:

1. A wideband antenna array comprising:
a wide angle impedance matching (waim) board;
a manifold board including a plurality of tower receiving features;
at least one conductive tower extending outward from the manifold board and received in a corresponding tower receiving feature, each of the at least one conductive towers including at least one metalized component, the metalized component forming a circuit connecting the manifold board to the waim board; and
wherein the waim board is adhered to a first end of the at least one conductive tower, the first end being opposite the manifold board.

2. The wideband antenna array of claim 1, wherein less than all of the tower receiving features receive a corresponding tower.

3. The wideband antenna array of claim 1, wherein each conductive tower is adhered to the manifold board via a conductive adhesive.

4. The wideband antenna array of claim 1, wherein each non-metalized tower comprises a tower portion having at least a first face and a second face, the first face including a first slot for receiving the at least one metalized component and the second face including a second slot for receiving a second one of the at least one metalized component.

5. The wideband antenna array of claim 4, wherein each of the first metalized component and the second metalized components are adhered in the corresponding slot via a conductive adhesive.

6. The wideband antenna array of claim 4, wherein each of the first and second metalized components includes a first tab protruding away from the conductive tower as a first end and a second tab protruding away from the conductive tower as a second end opposite the first end.

7. The wideband antenna array of claim 6, wherein each of the first tb and the second tab protrude normal to the corresponding one of the first face and the second face.

8. The wideband antenna array of claim 6, wherein one face of the first tab is adhered to the waim board via an electrically conductive adhesive.

9. The wideband antenna array of claim 1, wherein the waim board comprises at least a first conductive layer connecting the at least one conductive tower to a first non-conductive layer and a least a second conductive layer disposed on the first non-conductive layer opposite the first conductive layer.

10. The wideband antenna array of claim 9, wherein the first non-conductive layer is a foam.

11. The wideband antenna array of claim 9, wherein the waim board further comprises at least a second non-conductive layer disposed on the second conductive layer and a third conductive layer disposed on the second non-conductive layer opposite the second conductive layer.

12. The wideband antenna array of claim 1, wherein the conductive tower is constructed of a lightweight machinable material.

13. The wideband antenna array of claim 1, wherein the conductive tower is constructed of one of a metal- or conductive material-plated polyetherimide and a conductive polymer.

14. The wideband antenna array of claim 1, wherein each of the at least one conductive towers is substantially identical to each other of the at least one conductive towers.

15. A method for assembling a wideband antenna array comprising:
disposing a plurality of conductive towers in a manifold board such that a first end of each tower is received in a corresponding receiving feature of the manifold board;
disposing a wide-angle impedance matching (waim) board at a second end, opposite the first end, of each tower such that at least one metalized component of each conductive tower forms a circuit connecting the manifold board to the waim board; and
adhering the conductive tower to the manifold board and the waim board via one of a conductive solder and a conductive epoxy.

16. The method of claim 15, wherein each metalized tower comprises a tower portion having at least a first face and a second face, the first face including a first slot for receiving the at least one metalized component and the second face including a second slot for receiving a second one of the at least one metalized component, and wherein each of the first metalized component and the second metalized components are adhered in the corresponding slot via one of the conductive solder and the conductive epoxy.

17. The method of claim 16, wherein each of the first and second metalized components includes a first tab protruding away from the conductive tower as a first end and a second tab protruding away from the conductive tower as a second end opposite the first end each of the first tab and the second tab protruding normal to the corresponding one of the first face and the second face.

18. The method of claim 17, wherein one face of the first tab is adhered to the waim board via one of the conductive solder and the conductive epoxy.

19. The method of claim 15, wherein the waim board comprises at least a first conductive layer connecting the at least one conductive tower to a first non-conductive layer and a least a second conductive layer disposed on the first non-conductive layer opposite the first conductive layer, and wherein the first non-conductive layer is a foam.

20. The Method of claim 19, wherein the waim board further comprises at least a second non-conductive layer disposed on the second conductive layer and a third conductive layer disposed on the second non-conductive layer opposite the second conductive layer.
